(19) United States
(12) Patent Application Publication
(10) Pub. No.: US 2016/0187575 A1
(43) Pub. Date: Jun. 30, 2016

(54) BACKLIGHT MODULE AND DISPLAY DEVICE

(71) Applicant: Shenzhen China Star Optoelectronics Technology Co. Ltd., Shenzhen, Guangdong (CN)

(72) Inventor: Yong FAN, Shenzhen, Guangdong (CN)

(73) Assignee: Shenzhen China Star Optoelectronics Technology Co. Ltd., Shenzhen, Guangdong (CN)

(21) Appl. No.: 14/435,467

(22) PCT Filed: Jan. 14, 2015
(86) PCT No.: PCT/CN2015/070689

§ 371 Date: Apr. 14, 2015

(30) Foreign Application Priority Data
Dec. 26, 2014 (CN) 201410830678.2

(51) Int. Cl. F21V 8/00

(52) U.S. Cl. CPC G02B 6/0091; G02B 6/0068; G02B 6/0073

(57) ABSTRACT

The disclosure is related to a backlight module and a display device. The backlight module comprises a light guide plate, a first light bar, a second light bar and a plurality of first blockers. The light guide plate comprises a first surface and a second surface intersecting with the first surface. The first substrate is arranged close to the first surface of the light guide plate. The first light emitting diodes are arranged between the first substrate and the first surface of the light guide plate. The second light emitting diodes are arranged between the second substrate and the second surface of the light guide plate. The first blockers are arranged between the first substrate and the first surface of the light guide such that a first space is formed between the first light emitting diodes and the first surface of the light guide plate.

### CROSS REFERENCE TO RELATED APPLICATION

This application claims the benefit of, and priority to, Chinese Patent Application No. 201410830678.2, filed Dec. 26, 2014, titled “BACKLIGHT MODULE AND DISPLAY DEVICE”, the entire contents of which are incorporated by reference herein in its entirety.

### BACKGROUND OF THE INVENTION

1. Field of the Invention

The disclosure is related to the field of flat display, and more particularly to a backlight module and display device.

2. Description of Related Art

Liquid crystal display devices are common display devices, and prevail because of the features of low power consumption, small volume and lightweight. The liquid crystal display device usually comprises a backlight module and a display panel. The backlight module is used to provide surface light for the display panel. The backlight module usually comprises a light guide plate and a light source. The light source is usually arranged at the two opposite sides of the light guide plate to provide light to the light guide plate. The light guide plate is used to transform the light emitted from the light source as surface light. When there is expansion to the light guide plate because of being heated or absorbing moisture, the light guide plate extrudes the light source arranged at the tow opposite sides to further damage the light source. Or the light guide plate extrudes the light source arranged at the tow opposite sides of the light guide plate such that the light guide plate is damaged.

### SUMMARY OF THE INVENTION

One aspect of the disclosure relates to a backlight module. The backlight module comprises a light guide plate, a first light bar, a second light bar and a plurality of first blockers. The light guide plate comprises a first surface and a second surface intersecting with the first surface. The first light bar is arranged close to the first surface. The first light bar comprises a first substrate and a plurality of first light emitting diodes arranged separately on the first substrate. The first substrate is arranged close to the first surface of the light guide plate. The first light emitting diodes are arranged between the first substrate and the first surface of the light guide plate. The second light bar comprises a second substrate and a plurality of second light emitting diodes arranged separately on the second substrate. The second substrate is arranged close to second surface of the light guide plate. The second light emitting diodes are arranged between the second substrate and the second surface of the light guide plate. The first blockers are arranged between the first substrate and the first surface of the light guide such that a first space is formed between the first light emitting diodes and the first surface of the light guide plate.

In one embodiment of the backlight module, the first blockers are arranged uniformly between the first substrate and the first surface of the light guide plate.

In one embodiment of the backlight module, the backlight module further comprises a plurality of second blockers arranged between the second substrate and the second surface of the light guide plate such that a second space is formed between the second light emitting diodes and the second surface of the light guide plate.

In one embodiment of the backlight module, the second blockers are arranged uniformly between the second substrate and the second surface of the light guide plate.

In one embodiment of the backlight module, the backlight module further comprises a first elastic portion supporting the third surface of the light guide plate.

Another aspect of the disclosure relates to a display device comprising a backlight module. The backlight module comprises a light guide plate, a first light bar, a second light bar and a plurality of first blockers. The light guide plate comprises a first surface and a second surface intersecting with the first surface. The first light bar is arranged close to the first surface. The first light bar comprises a first substrate and a plurality of first light emitting diodes arranged separately on the first substrate. The first substrate is arranged close to the first surface of the light guide plate. The first light emitting diodes are arranged between the first substrate and the first surface of the light guide plate. The second light bar comprises a second substrate and a plurality of second light emitting diodes arranged separately on the second substrate. The second substrate is arranged close to second surface of the light guide plate. The second light emitting diodes are arranged between the second substrate and the second surface of the light guide plate. The first blockers are arranged between the first substrate and the first surface of the light guide such that a first space is formed between the first light emitting diodes and the first surface of the light guide plate.

In one embodiment of the display device, the first blockers are arranged uniformly between the first substrate and the first surface of the light guide plate.

In one embodiment of the display device, the backlight module further comprises a plurality of second blockers arranged between the second substrate and the second surface of the light guide plate such that a second space is formed between the second light emitting diodes and the second surface of the light guide plate.

In one embodiment of the display device, the second blockers are arranged uniformly between the second substrate and the second surface of the light guide plate.

In one embodiment of the display device, the backlight module further comprises a first elastic portion supporting the third surface of the light guide plate.

### BRIEF DESCRIPTION OF THE DRAWINGS

In order to more clearly illustrate the prior art or the embodiments or aspects of the practice of the disclosure, the accompanying drawings for illustrating the prior art or the embodiments of the disclosure are briefly described as below. It is apparently that the drawings described below are merely some embodiments of the disclosure, and those skilled in the art may derive other drawings according the drawings described below without creative endeavor.

FIG. 1 is a schematic structure of the backlight module according to one embodiment of the disclosure.

FIG. 2 is a schematic structure of the display device according to one embodiment of the disclosure.

### DETAILED DESCRIPTION OF THE PREFERRED EMBODIMENTS

The following description with reference to the accompanying drawings is provided to clearly and completely explain the exemplary embodiments of the disclosure. It is apparent that the following embodiments are merely some embodiments of the disclosure rather than all embodiments of the disclosure. According to the embodiments in the disclosure, all the other embodiments attainable by those skilled in the art without creative endeavor belong to the protection scope of the disclosure.

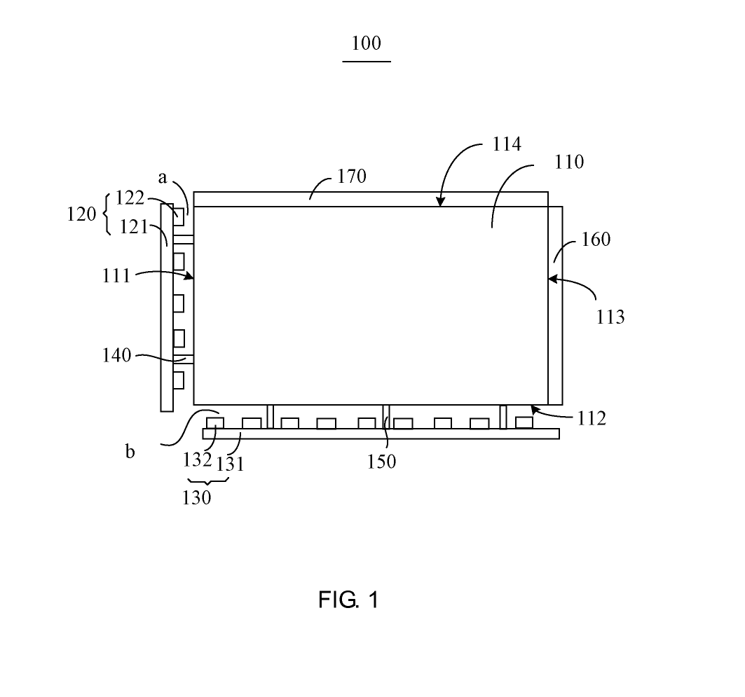

Refer to FIG. 1. FIG. 1 is a schematic structure of the backlight module according to one embodiment of the disclosure. The backlight module 100 comprises a light guide plate 110, a first light bar 120, a second light bar 130 and a plurality of first blockers 140. The light guide plate 110 comprises a first surface 111 and a second surface 112 intersecting with the first surface 111. The first light bar 120 is arranged close to the first surface 111. The first light bar 120 comprises a first substrate 121 and a plurality of first light emitting diodes 122 arranged separately on the first substrate 121. The first substrate 121 is arranged close to the first surface 111 of the light guide plate 110. The first light emitting diodes 122 are arranged between the first substrate 121 and the first surface 111 of the light guide plate 110. The second light bar 120 comprises a second substrate 121 and a plurality of second light emitting diodes 122 arranged separately on the second substrate 121. The second substrate 121 is arranged close to second surface 112 of the light guide plate 110. The second light emitting diodes 122 are arranged between the second substrate 121 and the second surface 112 of the light guide plate 110. The first blockers 140 are arranged between the first substrate 121 and the first surface 111 of the light guide 110 such that a first space a is formed between the first light emitting diodes 122 and the first surface 111 of the light guide plate 110.

In one embodiment of the backlight module, the first blockers 140 are arranged uniformly between the first substrate 121 and the first surface 111 of the light guide plate 110. In one embodiment, one end of the first blocker 140 supports the first substrate 121, and the other end of the first blocker 140 supports the first surface 111 of the light guide plate 110. By way of configuring the first blockers 140 between the first substrate 121 and the first surface 111 of the light guide plate 110, a first space a is formed between the first substrate 121 and the first surface 111 of the light guide plate 110 to avoid extrusion to the first light emitting diodes 122 caused by the expansion due to heat applied on or moisture absorbed by the light guide plate 110. Thus the first light emitting diodes 122 are protected from being damaged. Further, the first blockers 140 are arranged uniformly between the first substrate 121 and the first surface 111 of the light guide plate 110. When there is extrusion to the first light emitting diodes 122 caused by the expansion due to heat applied on or moisture absorbed by the light guide plate 110, the first blockers 140 uniformly apply forces on the light guide plate 110 such that the damage on the light guide plate 110 caused by uneven force may be prevented. Furthermore, one end of the first blocker 140 supports the first substrate 121, and the other end supports the first surface 111 to ensure a minimum distance between the first light emitting diodes 122 and the first surface 111 of the light guide plate 110. The optical coupling efficiency of the light beam entering to the first surface 111 of the light guide plate 110 is increased, and the leakage of the light emitted from the first light emitting diodes 122 is decreased.

The backlight module 100 further comprises a plurality of second blockers 150. The second blockers 150 are arranged between the second substrate 131 and the second surface 112 of the light guide plate 110 such that a second space b is formed between the second light emitting diodes 132 and the second surface 112 of the light guide plate 110. In one embodiment of the backlight module, the second blockers 150 are arranged uniformly between the second substrate 121 and the second surface 112 of the light guide plate 110. In one embodiment, one end of the second blockers 150 supports the first substrate 121, and the other end of the second blocker 150 supports the second surface 112 of the light guide plate 110. By way of configuring the second blocker 150 between the second substrate 131 and the second surface 112 of the light guide plate 110, a second space b is formed between the second substrate 131 and the second surface 112 of the light guide plate 110 to avoid extrusion to the second light emitting diodes 132 caused by the expansion due to heat applied on or moisture absorbed by the light guide plate 110. Thus the second light emitting diodes 132 are protected from being damaged. Further, the second blockers 150 are arranged uniformly between the second substrate 131 and the second surface 110 of the light guide plate 110. When there is extrusion to the light guide plate 110 caused by the expansion due to heat applied on or moisture absorbed by the light guide plate 110, the second blockers 150 uniformly apply forces on the light guide plate 110 such that the damage on the light guide plate 110 caused by uneven force may be prevented. Furthermore, one end of the second blocker 150 supports the second substrate 112, and the other end supports the second surface 112 of the light guide plate 110 to ensure a minimum distance between the second light emitting diodes 132 and the second surface 112 of the light guide plate 110. The optical coupling efficiency of the light beam entering to the second surface 112 of the light guide plate 110 is increased, and the leakage of the light emitted from the second light emitting diodes 132 is decreased.

The light guide plate 110 further comprises a third surface 113 opposite to the first surface 111. The backlight module 100 further comprises a first elastic part 160. The first elastic part 160 supports the third surface 113 of the light guide plate 110 when the first elastic part 160 shrinks due to the extrusion. In the embodiment, the material of the first elastic part 160 is rubber. When the light guide plate 110 has expansion because of being heated or absorbing moisture, the first blocker 140 arranged close to the first surface 111 stops the light guide plate 110 from extruding the first light emitting diodes 122 from the first surface 111. At this time, the light guide plate 110 extrudes the first elastic part 160 from the third surface 113. Because the first elastic part 160 has elasticity for shrinking when being extruded, the light guide plate 110 is protected from being damaged to some extent.

The light guide plate 110 further comprises a forth surface 114 opposite to the second surface 112. The backlight module 100 further comprises a second elastic part 170. The second elastic part 170 supports the forth surface 114 of the light guide plate 110 when the second elastic part 170 shrinks due to the extrusion. In the embodiment, the material of the second elastic part 170 is rubber. When the light guide plate 110 has expansion because of being heated or absorbing moisture, the second blocker 150 arranged close to the second surface 112 stops the light guide plate 110 from extruding the second light emitting diodes 132 from the second surface 112. At this time, the light guide plate 110 extrudes the second elastic part 170 from the third surface 113. Because the second elastic part 170 has elasticity for shrinking when being extruded, the light guide plate 110 is protected from being damaged to some extent.

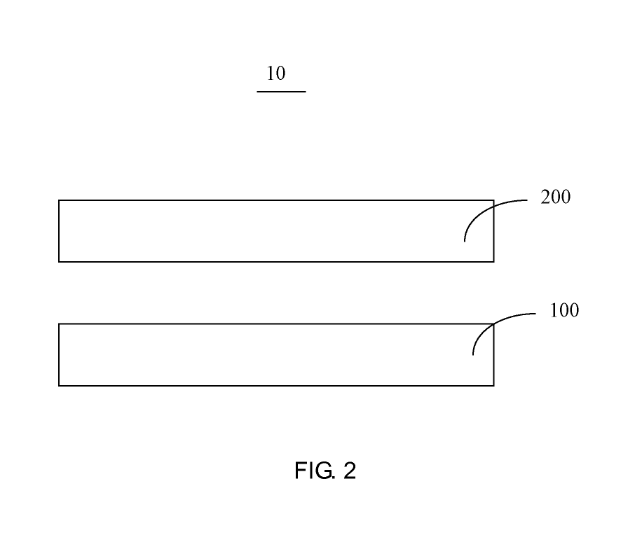

The display device is introduced as below in conjunction with FIG. 1. Refer to FIG. 2. FIG. 2 is a schematic structure of the display device according to one embodiment of the disclosure. The display device 10 comprises the backlight module 100 as shown in FIG. 1 and a display panel 200. The backlight module 100 is used to provide surface light source to the display panel 200.

The backlight module 100 comprises a light guide plate 110, a first light bar 120, a second light bar 130 and a plurality of first blockers 140. The light guide plate 110 comprises a first surface 111 and a second surface 112 intersecting with the first surface 111. The first light bar 120 is arranged close to the first surface 111. The first light bar 120 comprises a first substrate 121 and a plurality of first light emitting diodes 122 arranged separately on the first substrate 121. The first substrate 121 is arranged close to the first surface 111 of the light guide plate 110. The first light emitting diodes 122 are arranged between the first substrate 121 and the first surface 111 of the light guide plate 110. The second light bar 120 comprises a second substrate 121 and a plurality of second light emitting diodes 122 arranged separately on the second substrate 121. The second substrate 121 is arranged close to second surface 112 of the light guide plate 110. The second light emitting diodes 122 are arranged between the second substrate 121 and the second surface 112 of the light guide plate 110. The first blockers 140 are arranged between the first substrate 121 and the first surface 111 of the light guide 110 such that a first space a is formed between the first light emitting diodes 122 and the first surface 111 of the light guide plate 110.

In one embodiment of the backlight module, the first blockers 140 are arranged uniformly between the first substrate 121 and the first surface 111 of the light guide plate 110. In one embodiment, one end of the first blocker 140 supports the first substrate 121, and the other end of the first blocker 140 supports the first surface 111 of the light guide plate 110. By way of configuring the first blockers 140 between the first substrate 121 and the first surface 111 of the light guide plate 110, a first space a is formed between the first substrate 121 and the first surface 111 of the light guide plate 110 to avoid extrusion to the first light emitting diodes 122 caused by the expansion due to heat applied on or moisture absorbed by the light guide plate 110. Thus the first light emitting diodes 122 are protected from being damaged. Further, the first blockers 140 are arranged uniformly between the first substrate 121 and the first surface 111 of the light guide plate 110. When there is extrusion to the first light emitting diodes 122 caused by the expansion due to heat applied on or moisture absorbed by the light guide plate 110, the first blockers 140 uniformly apply forces on the light guide plate 110 such that the damage on the light guide plate 110 caused by uneven force may be prevented. Furthermore, one end of the first blocker 140 supports the first substrate 121, and the other end supports the first surface 111 to ensure a minimum distance between the first light emitting diodes 122 and the first surface 111 of the light guide plate 110. The optical coupling efficiency of the light beam entering to the first surface 111 of the light guide plate 110 is increased, and the leakage of the light emitted from the first light emitting diodes 122 is decreased.

The backlight module 100 further comprises a plurality of second blockers 150. The second blockers 150 are arranged between the second substrate 131 and the second surface 112 of the light guide plate 110 such that a second space b is formed between the second light emitting diodes 132 and the second surface 112 of the light guide plate 110. In one embodiment of the backlight module, the second blockers 150 are arranged uniformly between the second substrate 121 and the second surface 112 of the light guide plate 110. In one embodiment, one end of the second blockers 150 supports the first substrate 121, and the other end of the second blocker 150 supports the second surface 112 of the light guide plate 110. By way of configuring the second blocker 150 between the second substrate 131 and the second surface 112 of the light guide plate 110, a second space b is formed between the second substrate 131 and the second surface 112 of the light guide plate 110 to avoid extrusion to the second light emitting diodes 132 caused by the expansion due to heat applied on or moisture absorbed by the light guide plate 110. Thus the second light emitting diodes 132 are protected from being damaged. Further, the second blockers 150 are arranged uniformly between the second substrate 131 and the second surface 110 of the light guide plate 110. When there is extrusion to the light guide plate 110 caused by the expansion due to heat applied on or moisture absorbed by the light guide plate 110, the second blockers 150 uniformly apply forces on the light guide plate 110 such that the damage on the light guide plate 110 caused by uneven force may be prevented. Furthermore, one end of the second blocker 150 supports the second substrate 112, and the other end supports the second surface 112 of the light guide plate 110 to ensure a minimum distance between the second light emitting diodes 132 and the second surface 112 of the light guide plate 110. The optical coupling efficiency of the light beam entering to the second surface 112 of the light guide plate 110 is increased, and the leakage of the light emitted from the second light emitting diodes 132 is decreased.

The light guide plate 110 further comprises a third surface 113 opposite to the first surface 111. The backlight module 100 further comprises a first elastic part 160. The first elastic part 160 supports the third surface 113 of the light guide plate 110 when the first elastic part 160 shrinks due to the extrusion. In the embodiment, the material of the first elastic part 160 is rubber. When the light guide plate 110 has expansion because of being heated or absorbing moisture, the first blocker 140 arranged close to the first surface 111 stops the light guide plate 110 from extruding the first light emitting diodes 122 from the first surface 111. At this time, the light guide plate 110 extrudes the first elastic part 160 from the third surface 113. Because the first elastic part 160 has elasticity for shrinking when being extruded, the light guide plate 110 is protected from being damaged to some extent.

The light guide plate 110 further comprises a forth surface 114 opposite to the second surface 112. The backlight module 100 further comprises a second elastic part 170. The second elastic part 170 supports the forth surface 114 of the light guide plate 110 when the second elastic part 170 shrinks due to the extrusion. In the embodiment, the material of the second elastic part 170 is rubber. When the light guide plate 110 has expansion because of being heated or absorbing moisture, the second blocker 150 arranged close to the second surface 112 stops the light guide plate 110 from extruding the second light emitting diodes 132 from the second surface 112. At this time, the light guide plate 110 extrudes the second elastic part 170 from the third surface 113. Because the second elastic part 170 has elasticity for shrinking when being extruded, the light guide plate 110 is protected from being damaged to some extent.

Note that the specifications relating to the above embodiments should be construed as exemplary rather than as limitative of the present disclosure. The equivalent variations and modifications on the structures or the process by reference to the specification and the drawings of the disclosure, or application to the other relevant technology fields directly or indirectly should be construed similarly as falling within the protection scope of the disclosure.

What is claimed is:

1. A backlight module, comprising:
a light guide plate comprising a first surface and a second surface intersecting with the first surface;
a first light bar arranged close to the first surface, the first light bar comprising a first substrate and a plurality of first light emitting diodes arranged separately on the first substrate, the first substrate arranged close to the first surface of the light guide plate, the first light emitting diodes arranged between the first substrate and the first surface of the light guide plate;
a second light bar comprising a second substrate and a plurality of second light emitting diodes arranged separately on the second substrate, the second substrate arranged close to second surface of the light guide plate, the second light emitting diodes arranged between the second substrate and the second surface of the light guide plate; and
a plurality of first blockers arranged between the first substrate and the first surface of the light guide such that a first space is formed between the first light emitting diodes and the first surface of the light guide plate.

2. The backlight module according to claim 1, wherein the first blockers are arranged uniformly between the first substrate and the first surface of the light guide plate.

3. The backlight module according to claim 1, further comprising a plurality of second blockers arranged between the second substrate and the second surface of the light guide plate such that a second space is formed between the second light emitting diodes and the second surface of the light guide plate.

4. The backlight module according to claim 3, wherein the second blockers are arranged uniformly between the second substrate and the second surface of the light guide plate.

5. The backlight module according to claim 1, wherein the light guide plate further comprises a third surface opposite to the first surface, and a first elastic portion supporting the third surface of the light guide plate.

6. A display device comprising a backlight module, the backlight module comprising:
a light guide plate comprising a first surface and a second surface intersecting with the first surface;
a first light bar arranged close to the first surface, the first light bar comprising a first substrate and a plurality of first light emitting diodes arranged separately on the first substrate, the first substrate arranged close to the first surface of the light guide plate, the first light emitting diodes arranged between the first substrate and the first surface of the light guide plate;
a second light bar comprising a second substrate and a plurality of second light emitting diodes arranged separately on the second substrate, the second substrate arranged close to second surface of the light guide plate, the second light emitting diodes arranged between the second substrate and the second surface of the light guide plate; and
a plurality of first blockers arranged between the first substrate and the first surface of the light guide such that a first space is formed between the first light emitting diodes and the first surface of the light guide plate.

7. The display device according to claim 6, wherein the first blockers are arranged uniformly between the first substrate and the first surface of the light guide plate.

8. The display device according to claim 6, further comprising a plurality of second blockers arranged between the second substrate and the second surface of the light guide plate such that a second space is formed between the second light emitting diodes and the second surface of the light guide plate.

9. The display device according to claim 8, wherein the second blockers are arranged uniformly between the second substrate and the second surface of the light guide plate.

10. The display device according to claim 6, wherein the light guide plate further comprises a third surface opposite to the first surface, and a first elastic portion supporting the third surface of the light guide plate.
